(19) United States
(12) Patent Application Publication
(10) Pub. No.: US 2026/0359000 A1
(43) Pub. Date: Nov. 12, 2026

(54) VOLUME DYNAMIC ADJUSTMENT METHOD AND MEDIA PLAYER SYSTEM

(71) Applicant: Realtek Semiconductor Corporation, Hsinchu (TW)

(72) Inventor: Li-Po CHOU, Hsinchu (TW)

(21) Appl. No.: 19/646,612

(22) Filed: Apr. 14, 2026

(30) Foreign Application Priority Data
May 7, 2025 (TW) 114117231

(51) Int. Cl. G06F 3/16; G10L 25/93; H04R 3/12

(52) U.S. Cl. CPC G06F 3/165; G10L 25/93; H04R 3/12; H04R 2430/01

(57) ABSTRACT

A volume dynamic adjustment method and a media player system are provided. The volume dynamic adjustment method includes following steps. An input audio signal is received. An input audio decibel value corresponding to the input audio signal is calculated. A sum of the input audio decibel value and a system volume gain value is compared respectively with a maximum threshold and a minimum threshold, so as to generate a comparison result. The system volume gain value is dynamically adjusted based on the comparison result to generate a dynamic volume gain value. The input audio signal is played according to the dynamic volume gain value.

### CROSS-REFERENCE TO RELATED APPLICATIONS

This application claims the priority benefit of Taiwan patent application number 114117231, filed on May 7, 2025, which is hereby incorporated by reference herein and made a part of this specification.

### BACKGROUND

The present disclosure relates to media playback methods and media player systems, and more particularly, to media playback methods and systems capable of dynamically adjusting playback volume.

### FIELD OF INVENTION

### Description of Related Art

When users listen to music, watch videos, or hear advertisements or broadcasts in various settings, such as at home, in an office, in a vehicle, or at a public transportation station, they often encounter inconsistent volume levels between consecutive pieces of audio content. When one audio track ends and the next begins, the new audio content may be excessively loud or too quiet due to inherent differences in their recording levels. A significant volume difference, for instance, where a quiet song is followed by a loud one, can cause discomfort or startle the user.

Typically, this requires the user to manually adjust the volume to prevent it from being either piercingly loud or inaudibly soft. However, the need for frequent manual adjustments is highly inconvenient. This is especially problematic when the user is driving a vehicle, as operating volume controls can be a dangerous distraction. Therefore, there is a need for a solution that can automatically manage audio volume to enhance user experience and safety.

### SUMMARY

According to one aspect of the present disclosure, a volume dynamic adjustment method is provided. The method comprises receiving an input audio signal. An input audio decibel value corresponding to the input audio signal is calculated. A sum of the input audio decibel value and a system volume gain value is compared with a maximum threshold and a minimum threshold, respectively, to generate a comparison result. Based on the comparison result, the system volume gain value is dynamically adjusted to generate a dynamic volume gain value. The input audio signal is then played according to the dynamic volume gain value.

According to another aspect of the present disclosure, a media player system is provided. The system comprises a speaker array, a microphone array, and an embedded system coupled to the speaker array and the microphone array. The embedded system is configured to dynamically adjust a playback volume of an input audio signal. The embedded system is configured to calculate an input audio decibel value corresponding to the input audio signal, compare a sum of the input audio decibel value and a system volume gain value with a maximum threshold and a minimum threshold to generate a comparison result, dynamically adjust the system volume gain value based on the comparison result to generate a dynamic volume gain value, and drive the speaker array to play the input audio signal based on the dynamic volume gain value.

### BRIEF DESCRIPTION OF THE DRAWINGS

The disclosure can be more fully understood by reading the following detailed description of the embodiment, with reference made to the accompanying drawings as follows:

FIG. 1 is a schematic block diagram illustrating a media player system according to an embodiment of the present disclosure.

FIG. 2 is a flowchart illustrating a volume dynamic adjustment method according to an embodiment of the present disclosure.

FIG. 3 is a schematic diagram illustrating an exemplary placement of microphones of a microphone array and speakers of a speaker array in different environmental zones within a vehicle.

FIG. 4 is a flowchart illustrating a volume dynamic adjustment method according to another embodiment of the present disclosure.

### DETAILED DESCRIPTION

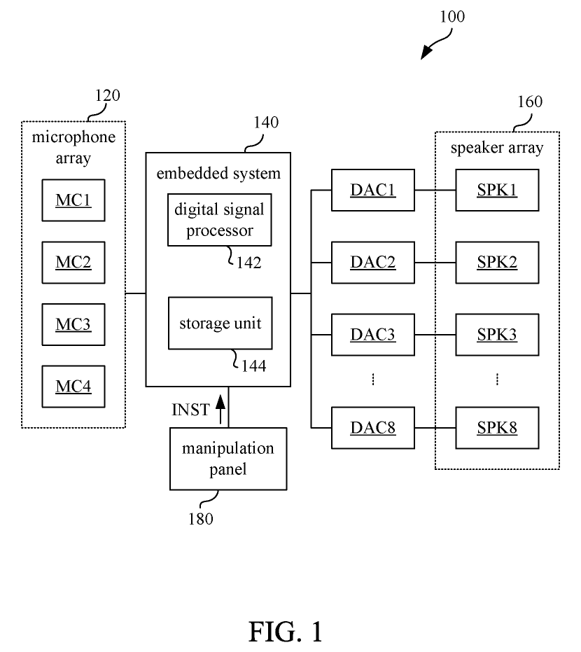

Reference is made to FIG. 1, which is a schematic block diagram illustrating a media player system 100 according to some embodiments of the present disclosure. As illustrated in the embodiment of FIG. 1, the media player system 100 includes a microphone array 120, an embedded system 140, a speaker array 160, and a manipulation panel 180.

The media player system 100 is configured to process an input audio signal to be played (which may include music, audio from videos, phone call content, navigation prompts, or application notification sounds). The media player system 100 performs dynamic volume adjustment based on the specific input audio content and environmental conditions, and drives the speaker array 160 to play the input audio signal according to the adjusted volume. This allows a playback volume of the input audio signal to be automatically modulated and maintained at an appropriate level, preventing drastic volume changes between consecutive audio inputs (e.g., between two songs, between a video and an advertisement, or between two different video clips). This enhances the user's listening comfort, reduces the need for manual adjustments, and increases convenience. The functions of the media player system 100 of the disclosure will be further described in the subsequent embodiments.

In this embodiment, the embedded system 140 is coupled to the speaker array 160. The embedded system 140 is configured to dynamically adjust the playback volume of the input audio signal and drive the speaker array 160 based on the adjusted playback volume. The embedded system 140 includes a digital signal processor (DSP) 142 and a storage unit 144. The digital signal processor 142 is configured to perform audio signal processing, control output volume, recognize human voices, and calculate the loudness of the input audio. The storage unit 144 may be a hard disk, flash memory, dynamic random-access memory (DRAM), or other equivalent storage device.

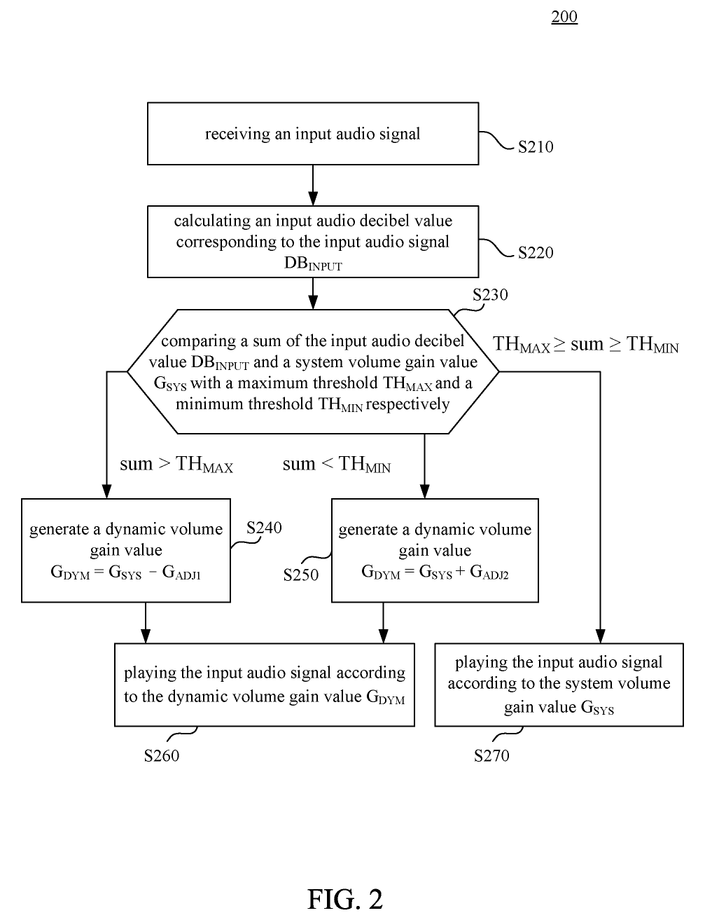

Reference is further made to FIG. 2, which is a flowchart illustrating a volume dynamic adjustment method 200 according to an embodiment of the present disclosure. First, at step S210, the embedded system 140 receives an input audio signal from an audio source (which may be a wireless broadcast, a smartphone, a video player, a music player, a navigation software application, etc.).

Next, at step S220, the digital signal processor 142 of the embedded system 140 calculates an input audio decibel value DB_{INPUT} corresponding to the input audio signal.

In one embodiment, the input audio signal may be a continuous audio stream in Pulse-Code Modulation (PCM) format, or in another similar audio transmission format. The Pulse-Code Modulation format is a raw digital audio format where volume intensity is reflected in the amplitude value of each sample point. In the Pulse-Code Modulation format, each sample point is represented by a binary number indicating an instantaneous amplitude of the sound.

In step S220, the digital signal processor 142 obtains an absolute value of the amplitude of each sample point of the input audio signal (to eliminate the effect of positive/negative signs), calculates an average value over a period of time, and then performs a logarithmic conversion to generate the input audio decibel value DB_{INPUT}.

In one embodiment, at step S220, an initial segment of the input audio signal to be played is pre-loaded (e.g., the first 30 seconds or the first 10% of the input audio signal). An average decibel value is then calculated based on this initial segment, and this average decibel value is utilized as the input audio decibel value DB_{INPUT}. This approach is suitable for input audio that is predictable and with a longer duration, such as a music file. For example, the next song in a playlist can be pre-loaded for this calculation.

In another embodiment, at step S220, a decibel value of a current segment of the input audio signal is calculated in real-time and is utilized as the input audio decibel value DB_{INPUT}. This approach is suitable for input audio that is highly time-sensitive, such as event notification sounds or mobile phone call content.

The input audio signal may comprise a PCM header and a series of audio frames. For example, with a sampling rate of 48 kHz, each second of input audio may contain 48,000 audio frames (from a 1st audio frame to a 48,000th audio frame). In one embodiment, to reduce the computational complexity of step S220, a portion of the audio frames in the input audio signal is sampled at intervals to generate a sampling result, thereby reducing the computational load. The input audio decibel value DB_{INPUT} is then estimated based on the sampling result (the sampled portion of audio frames).

For example, if sampling at intervals is performed every 4 frames (i.e., downsampling), the 1st, 5th, 9th, 13th frames, and so on, can be sampled. This reduces the amount of sampled data to one-fourth of the original. The frames that are not sampled (e.g., the 2nd to 4th audio frames) are not used in the calculation, which can reduce the computational load of step S220.

If sampling is performed at an interval of N frames, the 1st, (1+N)th, (1+2N)th, (1+3N)th frames, etc., are sampled. This reduces the data volume to 1/N, thereby lowering the computational load of step S220.

Next, at step S230, the input audio decibel value DB_{INPUT} is added to a system volume gain value G_{SYS}. The sum (i.e., DB_{INPUT} + G_{SYS}) is then compared with a maximum threshold TH_{MAX} and a minimum threshold TH_{MIN}, respectively, to generate a comparison result.

The system volume gain value G_{SYS} represents the current amplification/attenuation ratio used by the embedded system 140 for audio playback. If there is no additional dynamic adjustment, the sum of the input audio decibel value DB_{INPUT} and the system volume gain value G_{SYS} constitutes the playback volume of the input audio signal applied on the speaker array 160.

The system volume gain value G_{SYS} can be determined by a manual volume adjustment input INST from a user or by a system default value. For example, the user can provide a manual volume adjustment input INST by operating the manipulation panel 180 (e.g., turning a volume knob, pressing volume up/down buttons). The embedded system 140 can increase or decrease the system volume gain value G_{SYS} upon receiving the manual volume adjustment input INST.

For example, if the system volume gain value G_{SYS} is preset to -20dB, pressing the volume up button can raise G_{SYS} to -10dB. Conversely, pressing the volume down button can lower G_{SYS} to -30dB.

In one embodiment, the maximum threshold TH_{MAX} and the minimum threshold TH_{MIN} are preset values defining a suitable volume range. For example, assuming a suitable volume range in a quiet and comfortable vehicle is between -30dB and -50dB, the maximum threshold TH_{MAX} could be set to -30dB and the minimum threshold TH_{MIN} could be set to -50dB.

In another embodiment, the values of TH_{MAX} and TH_{MIN} can be determined by referencing the user's listening habits over a period of time. For example, manual volume adjustment inputs INST from the user can be collected to determine the user's preferred listening volume range, which then informs the setting of TH_{MAX} and TH_{MIN}.

In practical applications, inherent volume levels of different input audio signals (e.g., music tracks from different recording companies, commercials from different advertisers, broadcast programs versus inserted ads) can vary. Step S230 will yield different results depending on the inherent volume of the input audio.

If the input audio itself is loud, for example, if the input audio decibel value DB_{INPUT} is +5dB, and the system volume gain value G_{SYS} is preset to -20dB, the sum is -15dB, which is greater than TH_{MAX} (-30dB). In this case, the sum of DB_{INPUT} and G_{SYS} exceeds the maximum threshold TH_{MAX}. The volume dynamic adjustment method 200 proceeds to step S240. Based on the comparison result (DB_{INPUT} + G_{SYS} > TH_{MAX}), the system volume gain value G_{SYS} is dynamically adjusted to generate a dynamic volume gain value G_{DYM}. In this example, step S240 involves subtracting a first gain adjustment value G_{ADJ1} from the system volume gain value G_{SYS} to generate the dynamic volume gain value G_{DYM} (i.e., G_{DYM} = G_{SYS} - G_{ADJ1}), thereby achieving a dynamic volume reduction.

A magnitude of the first gain adjustment value G_{ADJ1} can be a fixed value or can be dependent on the amount by which the sum of DB_{INPUT} and G_{SYS} exceeds TH_{MAX}.

Then, at step S260, the input audio signal is played according to the dynamic volume gain value G_{DYM}. A resulting playback volume of the input audio is DB_{INPUT} + G_{DYM} = DB_{INPUT} + G_{SYS} - G_{ADJ1}. In this scenario, even though the input audio itself is loud, after the dynamic adjustment with the first gain adjustment value G_{ADJ1}, the playback volume is correspondingly reduced, preventing it from exceeding the comfortable volume range and avoiding user discomfort.

On the other hand, if the input audio itself is quiet, for example, if the input audio decibel value DB_{INPUT} is -45dB, and the system volume gain value G_{SYS} is -20dB, the sum is -65dB, which is less than TH_{MIN} (-50dB). In this case, the sum is below the minimum threshold TH_{MIN}. The volume dynamic adjustment method 200 then proceeds to step S250. Based on the comparison result (DB_{INPUT} + G_{SYS} < TH_{MIN}), the system volume gain value G_{SYS} is dynamically adjusted to produce the dynamic volume gain value G_{DYM}. In this example, step S250 involves adding a second gain adjustment value G_{ADJ2} to the system volume gain value G_{SYS} to generate the dynamic volume gain value G_{DYM} (i.e., G_{DYM} = G_{SYS} + G_{ADJ2}), thereby achieving dynamic volume amplification.

Then, at step S260, the input audio signal is played according to the dynamic volume gain value G_{DYM}. A resulting playback volume of the input audio is DB_{INPUT} + G_{DYM} = DB_{INPUT} + G_{SYS} + G_{ADJ2}. In this situation, even though the input audio is quiet, after the dynamic adjustment with the second gain adjustment value G_{ADJ2}, the playback volume is correspondingly increased, preventing the issue of the user being unable to hear the input audio clearly.

A magnitude of the second gain adjustment value G_{ADJ2} can be a fixed value or can be dependent on the amount by which the sum of DB_{INPUT} and G_{SYS} falls below TH_{MIN}.

In one embodiment, the implementation of playing the input audio signal according to the dynamic volume gain value G_{DYM} at step S260 can be performed by the digital signal processor 142 within the embedded system 140 adjusting the playback volume of the input audio signal in software manner. For example, the digital signal processor 142 can amplify or attenuate the amplitude values of the input audio signal according to the dynamic volume gain value G_{DYM}.

In another embodiment, as shown in FIG. 1, there are digital-to-analog converters DAC1-DAC8 coupled between the embedded system 140 and the speakers SPK1-SPK8 of the speaker array 160. The digital-to-analog converter DAC1 is configured to drive speaker SPK1 to play the input audio signal, and similarly, the digital-to-analog converters DACs DAC2-DAC8 are configured to drive speakers SPK2-SPK8. In one embodiment, another implementation of playing the input audio signal at step S260 involves controlling the digital-to-analog converters DAC1-DAC8 (e.g., controlling their respective amplification factors) based on the dynamic volume gain value G_{DYM}, thereby adjusting the playback volume of the input audio signal in hardware manner.

On the other hand, when the input audio itself has a moderate volume, for example, if the input audio decibel value DB_{INPUT} is -20dB, the sum of the input audio decibel value DB_{INPUT} and the system volume gain value G_{SYS} is -40dB, which falls between the maximum threshold TH_{MAX} and the minimum threshold TH_{MIN}. In this case, the volume of the input audio does not require dynamic adjustment, and the method proceeds to step S270, where the input audio is played based on the system volume gain value G_{SYS}.

In one embodiment, during the execution of the volume dynamic adjustment method 200 by the embedded system 140, after step S210, the embedded system 140 can further identify audio content components within the input audio signal (not shown in FIG. 2). When the audio content component of the input audio signal comprises a navigation instruction sound, the embedded system 140 does not perform dynamic adjustment for the navigation instruction sound and plays it according to the system volume gain value G_{SYS} (as in step S270) without dynamic adjustment.

As described in the above embodiments, the media player system 100 executing the volume dynamic adjustment method 200 shown in FIG. 2 can perform automated dynamic gain adjustment based on the input audio decibel value DB_{INPUT} and apply the adjusted gain to the system volume gain value G_{SYS}, thereby obviating the need for manual user adjustment.

In another embodiment, in addition to referencing the input audio decibel value DB_{INPUT} for volume adjustment, the media player system 100 can further reference ambient audio signals collected by the microphone array 120 to adaptively adjust the playback volume of speakers at different positions within the speaker array 160.

In the embodiment of FIG. 1, the microphone array 120 includes microphones MC1, MC2, MC3 and MC4, and the speaker array 160 includes speakers SPK1, SPK2, SPK3...SPK8. The microphones MC1, MC2, MC3 and MC4 can be disposed in different environmental zones. Similarly, the speakers SPK1, SPK2, SPK3...SPK8 can also be disposed at different positions, each belonging to a respective environmental zone.

In this disclosure, the number of microphones in the microphone array 120 and the number of speakers in the speaker array 160 are not limited to a specific quantity but depend on the needs of the practical application.

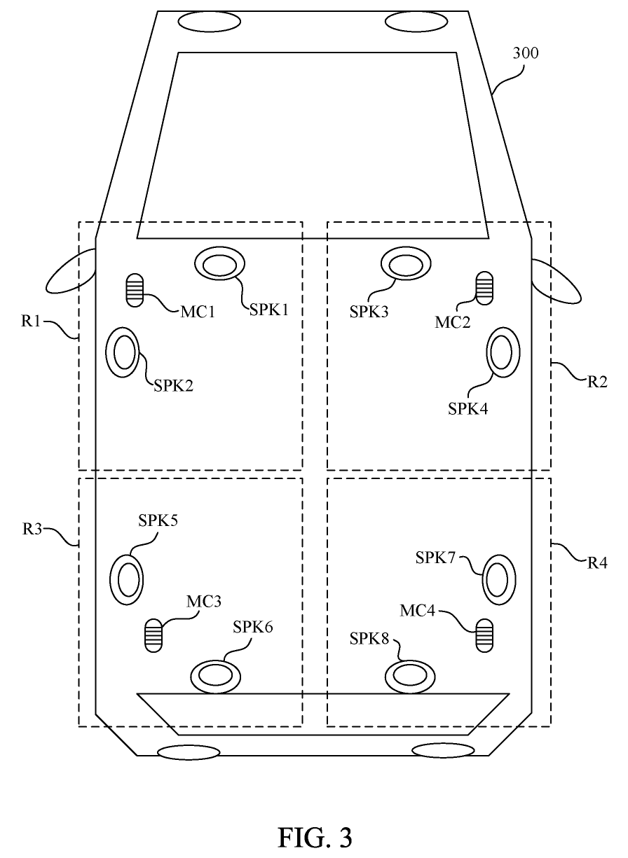

In one embodiment, the media player system 100 may be an in-vehicle media player system. Reference is further made to FIG. 3, which is a schematic diagram illustrating the placement of the microphones MC1-MC4 of the microphone array 120 and the speakers SPK1-SPK8 of the speaker array 160 in environmental zones R1-R4 within a vehicle 300.

In the embodiment shown in FIG. 3, the microphone MC1 and the speakers SPK1 and SPK2 are disposed in the environmental zone R1 of the vehicle 300 (the left-front seat area in this embodiment). The microphone MC2 and the speakers SPK3 and SPK4 are disposed in environmental zone R2 (the right-front seat area). The microphone MC3 and the speakers SPK5 and SPK6 are disposed in environmental zone R3 (the left-rear seat area). The microphone MC4 and the speakers SPK7 and SPK8 are disposed in environmental zone R4 (the right-rear seat area). The spatial correspondence (their respective environmental zones R1-R4) of the microphones MC1-MC4 and the speakers SPK1-SPK8 can be stored in the storage unit 144 by a lookup table, a correspondence table, or a map.

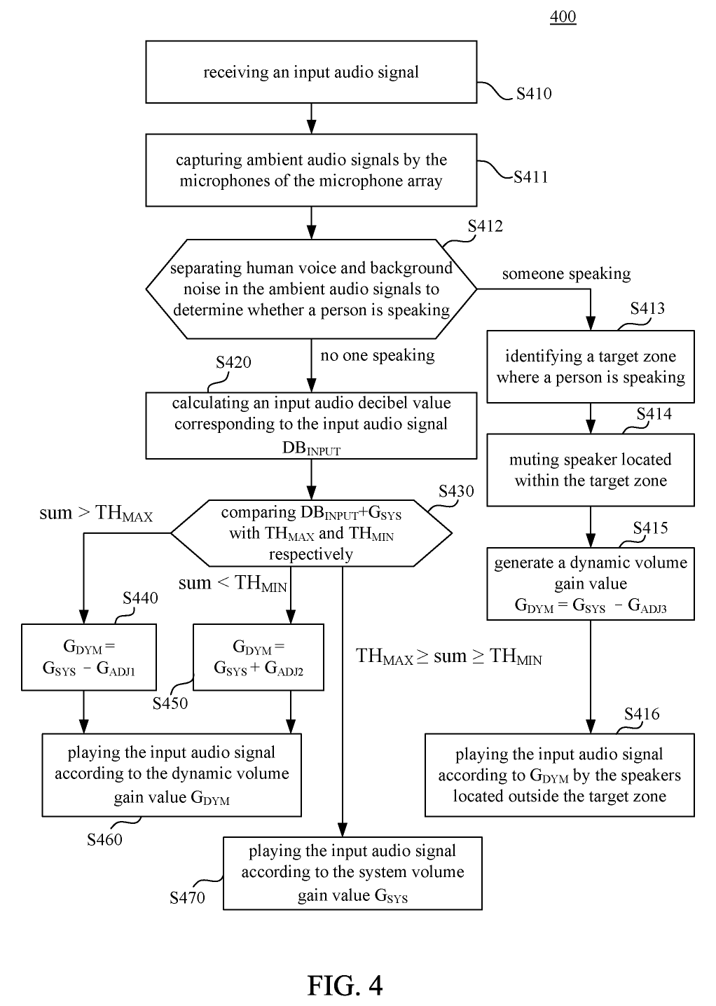

Reference is further made to FIG. 4, which is a flowchart illustrating a volume dynamic adjustment method 400 according to another embodiment of the disclosure. In the embodiment of FIG. 4, steps S410, S420, S430, S440, S450, S460 and S470 of the volume dynamic adjustment method 400 are similar to steps S210, S220, S230, S240, S250, S260 and S270 of the volume dynamic adjustment method 200 in the embodiment of FIG. 2, and their explanations will not be repeated here.

The difference is that the volume dynamic adjustment method 400 further includes steps S411-S416. As shown in FIGS. 3 and 4, after the embedded system 140 receives an input audio signal from an audio source (step S410), it executes step S411 to capture ambient audio signals by the microphones MC1-MC4 of the microphone array 120. The ambient audio signal captured by microphone MC1 reflects the real-time sound in environmental zone R1. Similarly, the ambient audio signals captured by microphones MC2-MC4 respectively reflect the real-time sounds in environmental zones R2-R4.

Next, at step S412, a human voice component and a background noise component are separated from the ambient audio signals captured by microphones MC1-MC4 to determine whether a person is speaking in any of the environmental zones R1-R4.

Since the speakers SPK1-SPK8 are simultaneously playing the input audio signal, the background noise component of the ambient audio signals consists mostly of the content of the input audio signal. In one embodiment, the step S412 of separating the human voice component from the background noise component of the ambient audio signals is achieved by performing a filtering operation between each of the ambient audio signals captured by the microphones MC1-MC4 and the input audio signal, thereby filtering out the content of the input audio signal to extract the human voice component.

Based on the volume level of the human voice component, it is determined whether a person is speaking in each of the environmental zones R1-R4.

If the volume dynamic adjustment method 400 determines that no one is speaking in any of the environmental zones R1-R4, it can proceed to steps S420 through S470. The relevant operations can be referred to in the description of steps S220 through S270 in the embodiment.

If it is determined that a person is speaking in one of the environmental zones R1-R4, the method proceeds to step S413. A target zone where a person is speaking is identified based on which of the environmental zones R1-R4 has the loudest human voice component. For instance, if the human voice component in the ambient audio signal captured by microphone MC4 is the loudest, it is determined that a person is speaking in environmental zone R4 (i.e., the right-rear seat area of the vehicle 300), which is identified as the current target zone.

Next, at step S414, the speakers SPK7 and SPK8 located within the target zone (i.e., environmental zone R4) are muted. Then, at step S415, in response to determining that a person is speaking, a third gain adjustment value G_{ADJ3} is subtracted from the system volume gain value G_{SYS} to generate the dynamic volume gain value G_{DYM}. The dynamic volume gain value G_{DYM} = G_{SYS} - G_{ADJ3}, thereby achieving a dynamic volume reduction.

Subsequently, at step S416, the speakers SPK1-SPK6 located outside the target zone (i.e., in environmental zones R1-R3) play the input audio signal according to the dynamically reduced dynamic volume gain value G_{DYM}.

That is to say, when it is determined that a person is speaking in environmental zone R4, the speakers SPK7 and SPK8 in the corresponding zone can be muted, and the playback volume of the other speakers SPK1-SPK6 throughout the vehicle is correspondingly lowered. This facilitates conversation among users within the vehicle 300 without requiring additional manual operation of the volume controls.

In one embodiment, during the execution of the volume dynamic adjustment method 400 by the embedded system 140, after step S410, the embedded system 140 can further identify audio content components within the input audio signal (not shown in FIG. 2). When the audio content component of the input audio signal includes a navigation instruction sound, the embedded system 140 does not perform dynamic adjustment for the navigation instruction sound and plays it according to the system volume gain value G_{SYS} (as in step S470) without dynamic amendment.

The volume dynamic adjustment function provided by the media player system 100 in the above embodiments can be toggled on or off via a corresponding control button on the manipulation panel 180. If a user finds the results of the automatic adjustment to be unsatisfactory, they can also disable it via the manipulation panel 180.

Through the above embodiments, the volume dynamic adjustment methods 200/400 and the media player system 100 of the disclosure can achieve dynamic adaptation to audio source variations. The volume can be automatically adjusted to an appropriate range even if the inherent volume of the input audio signals varies, and automatic zoned volume control can be performed. The system can locate the speaker's zone via the microphone array 120 and differentially adjust the speaker volumes inside and outside the target zone. When reducing music volume, specific audio (such as navigation prompts) can remain unaffected. By sampling only a portion of the audio frames for calculation, the system can accelerate decisions and reduce the overall computational load.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A volume dynamic adjustment method, comprising:
receiving an input audio signal;
calculating an input audio decibel value corresponding to the input audio signal;
comparing a sum of the input audio decibel value and a system volume gain value with a maximum threshold and a minimum threshold respectively, to generate a comparison result;
based on the comparison result, dynamically adjusting the system volume gain value to generate a dynamic volume gain value; and
playing the input audio signal according to the dynamic volume gain value.

2. The volume dynamic adjustment method of claim 1, wherein the step of dynamically adjusting the system volume gain value based on the comparison result comprises:
in response to the comparison result indicating that the sum is greater than the maximum threshold, subtracting a first gain adjustment value from the system volume gain value to generate the dynamic volume gain value; and
in response to the comparison result indicating that the sum is less than the minimum threshold, adding a second gain adjustment value to the system volume gain value to generate the dynamic volume gain value.

3. The volume dynamic adjustment method of claim 1, further comprising:
capturing a plurality of ambient audio signals using a plurality of microphones, wherein the plurality of microphones are disposed in a plurality of environmental zones;
separating a human voice component and a background noise component from the plurality of ambient audio signals to determine whether a person is speaking in any of the plurality of environmental zones; and
in response to determining that the person is speaking, subtracting a third gain adjustment value from the system volume gain value to generate the dynamic volume gain value.

4. The volume dynamic adjustment method of claim 3, wherein the step of separating the human voice component and the background noise component comprises performing a filtering operation between each of the plurality of ambient audio signals and the input audio signal to extract the human voice component.

5. The volume dynamic adjustment method of claim 3, further comprising:
based on the plurality of ambient audio signals, identifying a target zone where the person is speaking; and
while playing the input audio signal, muting at least one speaker located within the target zone.

6. The volume dynamic adjustment method of claim 1, wherein the input audio signal comprises a navigation instruction sound, the method further comprising:
identifying the navigation instruction sound within the input audio signal; and
playing the navigation instruction sound according to the system volume gain value without performing dynamic adjustment to the navigation instruction sound.

7. The volume dynamic adjustment method of claim 1, further comprising:
receiving a manual volume adjustment input; and increasing or decreasing the system volume gain value based on the manual volume adjustment input.

8. The volume dynamic adjustment method of claim 1, wherein the step of calculating the input audio decibel value comprises:
pre-loading an initial segment of the input audio signal to be played; and
calculating an average decibel value of the initial segment to utilize as the input audio decibel value.

9. The volume dynamic adjustment method of claim 1, wherein the step of calculating the input audio decibel value comprises:
calculating in real-time a decibel value of a current segment of the input audio signal to utilize as the input audio decibel value.

10. The volume dynamic adjustment method of claim 1, wherein the step of calculating the input audio decibel value comprises:
sampling, at intervals, a portion of audio frames from the input audio signal to generate a sampling result; and
estimating the input audio decibel value based on the sampling result.

11. The volume dynamic adjustment method of claim 1, wherein the step of playing the input audio signal according to the dynamic volume gain value comprises:
adjusting a playback volume of the input audio signal in software via a digital signal processor based on the dynamic volume gain value.

12. The volume dynamic adjustment method of claim 1, wherein a digital-to-analog converter is configured to drive a speaker to play the input audio signal, and wherein the step of playing the input audio signal according to the dynamic volume gain value comprises:
controlling the digital-to-analog converter based on the dynamic volume gain value to adjust a playback volume of the input audio signal.

13. A media player system, comprising:
a speaker array;
a microphone array; and
an embedded system coupled to the speaker array and the microphone array, the embedded system being configured to dynamically adjust a playback volume of an input audio signal, wherein the embedded system is configured to:
calculate an input audio decibel value corresponding to the input audio signal;
compare a sum of the input audio decibel value and a system volume gain value with a maximum threshold and a minimum threshold, respectively, to generate a comparison result;
based on the comparison result, dynamically adjust the system volume gain value to generate a dynamic volume gain value; and
drive the speaker array to play the input audio signal based on the dynamic volume gain value.

14. The media player system of claim 13, wherein the embedded system is further configured to:
in response to the comparison result indicating that the sum is greater than the maximum threshold, subtract a first gain adjustment value from the system volume gain value to generate the dynamic volume gain value; and
in response to the comparison result indicating that the sum is less than the minimum threshold, add a second gain adjustment value to the system volume gain value to generate the dynamic volume gain value.

15. The media player system of claim 13, wherein the microphone array comprises a plurality of microphones configured to capture a plurality of ambient audio signals from a plurality of environmental zones, and wherein the embedded system is further configured to:
separate a human voice component and a background noise component from the plurality of ambient audio signals to determine if a person is speaking in any of the plurality of environmental zones; and
in response to determining that the person is speaking, dynamically decrease the system volume gain value.

16. The media player system of claim 15, wherein the embedded system separates the human voice component by performing a filtering operation between each of the plurality of ambient audio signals and the input audio signal.

17. The media player system of claim 15, wherein the embedded system is further configured to:
identify a target zone where the person is speaking based on the plurality of ambient audio signals; and
mute at least one speaker of the speaker array located within the target zone while playing the input audio signal.

18. The media player system of claim 13, wherein the input audio signal comprises a navigation instruction sound, and wherein the embedded system is further configured to:
identify the navigation instruction sound within the input audio signal; and
drive the speaker array to play the navigation instruction sound according to the system volume gain value without the dynamic adjustment.

19. The media player system of claim 13, wherein the embedded system comprises a digital signal processor configured to adjust the playback volume of the input audio signal in software based on the dynamic volume gain value.

20. The media player system of claim 13, further comprising a digital-to-analog converter coupled between the embedded system and the speaker array, the digital-to-analog converter being configured to drive the speaker array to play the input audio signal, wherein the embedded system is configured to control the digital-to-analog converter based on the dynamic volume gain value to adjust the playback volume of the input audio signal.
